(19) United States
(12) Patent Application Publication
(10) Pub. No.: US 2007/0204033 A1
(43) Pub. Date: Aug. 30, 2007

(54) Methods and systems to detect abuse of network services

(76) Inventors: James Bookbinder, Leander, TX (US); Christopher Smith, Austin, TX (US); Paul Dent, Austin, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/361,931

(22) Filed: Feb. 24, 2006

(51) Int. Cl. G06F 15/173

(52) U.S. Cl. 709/224

(57) ABSTRACT

Methods, apparatus, and systems to detect abuse of network services are disclosed. An example method involves obtaining network service activity information associated with a plurality of network service accounts, comparing via a fraud detection system the network service activity information with a term of a service agreement of a service provider, and identifying abusive activity based on the comparison.

### FIELD OF THE DISCLOSURE

The present disclosure relates generally to processor systems and, more particularly, to methods and systems to detect abuse of network services.

### BACKGROUND

As the Internet grows in popularity, more and more people have adopted it as a standard medium for communicating and retrieving information for both business and personal matters. The Internet service provider (ISP) industry, which once constituted only a handful of small companies, has become a widely populated industry. As the Internet grows and becomes an increasingly acceptable vehicle for accessing and exchanging information, ISP's introduce more features to meet subscriber demands. No longer do ISP's merely provide access to the Internet. ISP's also offer additional or enhanced services such as, for example, web hosting services, web portal access, online content subscriptions (e.g., e-magazines, financial reports, financial news, music access, etc.), e-mail enhancements, online storage capacity, etc.

Internet services fraud is often a source of lost revenue for ISP's. Internet service fraud includes, for example, identity theft and e-mail spam. Identity theft includes opening new accounts using illegally obtained credit card information or obtaining existing account information through some improper means. E-mail spam, on the other hand, is often carried out by mass mailing large volumes of e-mail via an ISP's server and often modifying the sender's address to conceal the identity of the true sender.

Many other types of fraudulent activities occur in connection with the additional or enhanced services described above. For each service offering, an ISP often implements a separate server for storing account information and/or enrollment information to track subscribers who have entered into agreements to access those services. In some cases, ISP's enter into contractual agreements with third parties to offer third-party services via the ISP's communication networks. A de-centralized organization of record keeping arising from having a plurality of servers or storage locations for storing subscriber account information can make fraudulent activities difficult to detect by ISP's offering a variety of services.

### BRIEF DESCRIPTION OF THE DRAWINGS

FIG. 1 depicts an example network system for providing Internet services.

FIG. 2 depicts an example fraud detector and a plurality of information sources used to monitor network service activity and detect Internet services fraud.

FIG. 3 is a block diagram of the example fraud detector of FIG. 2.

FIGS. 4A, 4B, and 5 are flowcharts representative of machine readable instructions that may be executed to implement the example fraud detector of FIGS. 2 and 3 and other apparatus communicatively coupled thereto.

FIG. 6 is a flowchart representative of machine readable instructions that may be executed to implement a responsive action process in response to detecting fraud and/or abuse of Internet services.

FIG. 7 is a flowchart representative of machine readable instructions that may be executed to generate customer service messages for use in connection with handling calls to a customer service department of an Internet service provider from subscribers suspect of fraud and/or abuse.

FIG. 8 is a flowchart representative of machine readable instructions that may be executed to generate and update fraud and abuse pattern information for use in detecting subsequent fraud and abuse.

FIG. 9 is a flowchart representative of machine readable instructions that may be executed to implement a customer relationship management system and an interactive voice response system.

FIG. 10 is a block diagram of an example processor system that may be used to execute the example machine readable instructions of FIGS. 4A, 4B, 5-8, and/or 9 to implement the example systems and/or methods described herein.

### DETAILED DESCRIPTION

The example methods, systems, and/or apparatus described herein may be used to monitor network service activity and detect abuse of network services (e.g., abuse of Internet services). The example methods, systems, and/or apparatus may be implemented by one or more Internet service providers (ISP's) (e.g., telephone companies, cable companies, satellite communication companies, wireless mobile communication companies, utility companies, telecommunication companies, dedicated Internet providers, etc.) to protect itself and/or other subscribers against network abuse. As used herein, network abuse (e.g., Internet services abuse) may include, for example, fraud, identity theft, e-mail spam, posting copyright protected or otherwise prohibited information on web pages, etc.

Internet service providers often provide additional or enhanced services or features other than merely access to the Internet. For example, some ISP's offer web hosting services, web portal access, online content subscriptions (e.g., e-magazines, financial reports, financial news, music access, etc.), e-mail enhancements, online storage capacity, etc. For a particular subscriber, an ISP may create a primary account (e.g., a general account, a parent account, etc.) and a plurality of sub-accounts based on the number of enhanced or additional features or services in which the subscriber is enrolled. For example, a subscriber will typically have a primary account associated with a contractual agreement to obtain Internet access via the ISP's network. For each additional service or feature selected by the subscriber, the ISP may create a sub-account to store enrollment information associated with the subscriber, the level of service, and/or any other information associated with the selected additional service or feature. Sub-account information associated with additional features is often stored in servers or locations distributed throughout an ISP's network and/or in third-party networks. For example, as a new service is added to an ISP's product offering, one or more new servers may be added and/or communicatively coupled to an ISP's existing network to store software and data associated with the new service and/or enrollment or other account information associated with subscribers enrolled to access the new service.

Often, ISP's enter into contractual agreements with third-party service providers to provide features or services to the ISP's subscribers. For example, a third-party service provider may provide online content subscriptions (e.g., financial news or other news of interest), banking features, e-mail features, web hosting capabilities, online music access, file sharing capabilities, Internet search engines, etc. Sub-account information associated with third-party service providers may be stored at a server within the ISP's network or a server within the third-party's network. In either case, the enrollment information is typically stored separately from enrollment information associated with other services offered by the ISP.

Some of the most costly Internet services fraud activity for ISP's often arises from fraudulent enrollment information used to establish primary accounts and/or sub-accounts. For example, a user intending to generate spam e-mail or provide unlawful information (e.g., copyrighted works, viruses, etc.) on a web site may subscribe to one or more accounts and/or sub-accounts using false or stolen information (e.g., fake names, addresses, credit card numbers, etc.).

The distributed and/or decentralized configuration used to store enrollment information associated with enhanced or additional ISP services and third-party services makes it difficult for ISP's to detect Internet services fraud using known fraud detection techniques. For instance, when users commit fraud in connection with third-party services, ISP's often cannot track the fraudulent activity associated with the third-party services. However, the fraudulent activity associated with third-party services may compromise or increase costs associated with the contractual agreements between the ISP and third-party service providers. For example, users may introduce e-mail worms or other viruses to ISP networks and ISP subscribers via the third-party services and may conduct other activities (e.g., posting copyrighted works or other protected information) that give rise to legal liabilities between ISP's, third-party service providers, and subscribers.

Another distributed and/or decentralized account information storage configuration making it difficult to detect network abuse arises when relatively larger ISP's provide services throughout a large geographic region (e.g., a state, a country, or the world) using a plurality of different server sites located throughout the region. For example, a large ISP may have a plurality of server sites throughout a relatively large geographical region. Each server site has servers to store account information of subscribers accessing the ISP network from a respective geographic service area. As a result, account information stored in one server site is substantially isolated from account information stored in another server site.

In some cases, a parent or primary ISP is formed by the joining (e.g., via a merger) of two or more smaller ISP's (referred to herein as sub-ISP's), each having its own domain name and its own domain servers. Account information associated with a particular sub-ISP's domain name and domain servers may be isolated from the account information associated with other sub-ISP's domain name and servers. Users wishing to defraud the parent ISP may create temporary accounts using fraudulent information and bounce from one sub-ISP to another to evade detection and, thus, legal or other action against the fraudulent users. For example, fraudulent users whom have been detected of fraudulent and/or activity or that would like to preempt being detected are likely to abandon accounts and simply move on to create other accounts (i.e., account hopping) using the same or different fraudulent information.

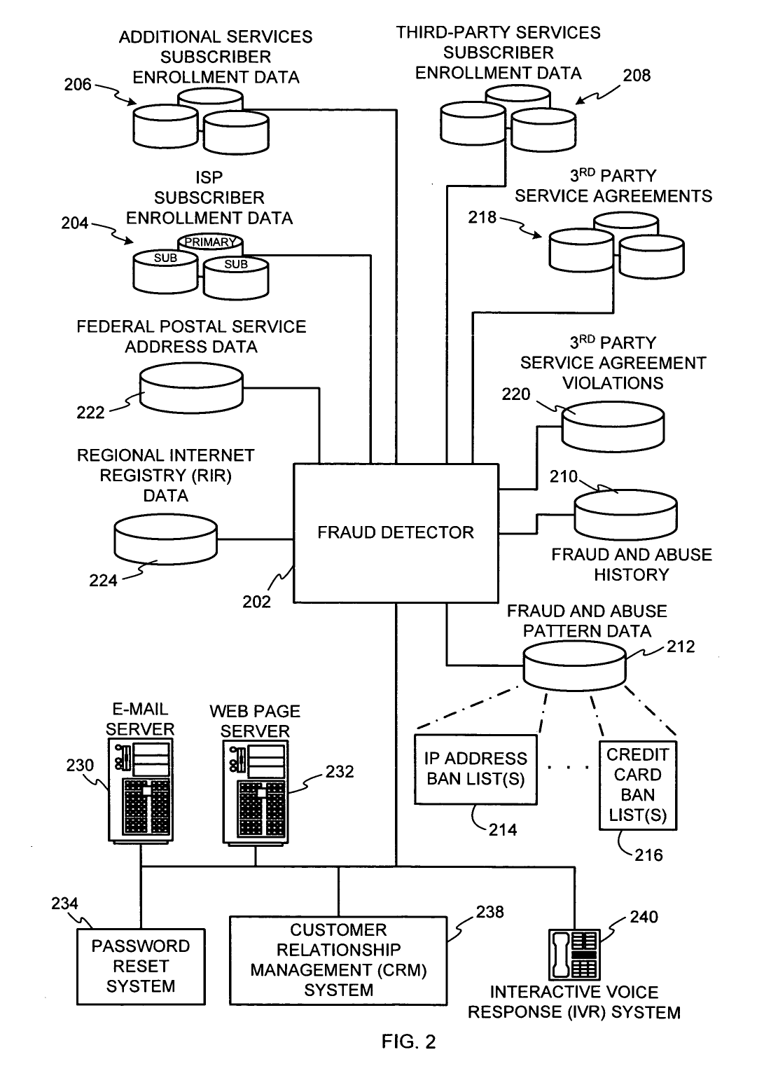

To address the problems associated with account hopping, the methods and systems described herein may be used to generate and update patterns of fraudulent activity based on account enrollment information stored throughout a decentralized or distributed ISP network. Specifically, as new account information is stored in servers distributed throughout an ISP's network, an example fraud detector 202 described below in connection with FIG. 2 monitors the account information and searches for suspicious information (e.g., false or inconsistent addresses, stolen or false credit card numbers, etc.) and/or fraudulent activity patterns based on historical pattern data and the new account data.

The example methods and systems described herein may also be used to detect network abuse associated with Internet services based on service agreements and Internet services activity information including account information and on-line user activity. For example, a primary or parent ISP typically offers Internet services conditional upon a user's agreement to abide by a plurality of terms contained within the primary ISP's service agreement. The terms may include a maximum number of e-mail addresses, a prohibited information condition (e.g., agreement to not post viruses, harmful information, banned information, copyrighted information or other protected works, etc.), a maximum number of simultaneous user logins, an agreement to use valid financial information (e.g., valid credit card accounts, valid bank accounts, etc.), an agreement to use the true name and address of a subscriber, etc. The example fraud detector 202 of FIG. 2 compares each term of a service agreement to a user's historic Internet activity information including subscriber primary account and sub-account information and on-line user activity to determine whether the user is in violation of the service agreement.

As described in detail below, the example methods and systems described herein may also be used to enable a primary Internet service provider to import third-party service agreements associated with third-party services offered via the primary ISP's communication channels. In this manner, the primary ISP may also compare terms of the third-party service agreements with historical subscriber Internet activity information to detect network abuse associated with Internet services.

The fraud detector 202 of the illustrated example may use any of a plurality of techniques to detect fraudulent account information and/or fraudulent and/or Internet usage activity. As described below, the fraud detector 202 may use network abuse pattern data that the fraud detector 202 generates and updates over time as it discovers new ways in which subscribers are participating in fraudulent and/or abusive behavior. Thus, the fraud detector 202 is configured to adaptively learn how to detect evolving fraudulent and/or abusive activity.

Even if an ISP is able to detect network abuse, it is often difficult for the ISP to contact the user regarding the network abuse. As also described below, to increase the chances of communicating with a user detected of network abuse, the example fraud detector 202 of the illustrated example is communicatively coupled to an ISP's customer service system (e.g., a customer relations management (CRM) system and an interactive voice response (IVR) system). In this manner, when network abuse is detected, the example fraud detector 202 can forward an alert or message to the customer service system and change a password or perform some other action on an account in violation to lure the account holder to contact customer service. The example fraud detector 202 provides the relevant network abuse information to a customer service representative to enable the representative to handle a call or communication with the account holder to stop or alleviate the network abuse.

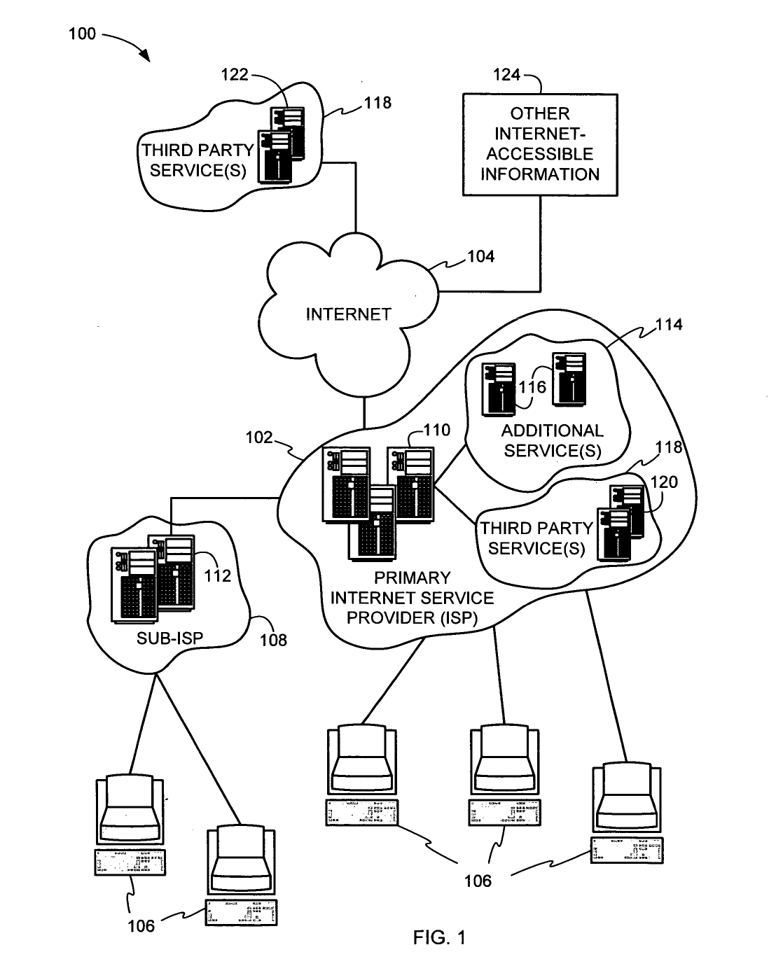

Now turning to FIG. 1, an example network system 100 for providing Internet services includes a primary ISP 102. The primary ISP 102 provides access to the Internet 104 to a plurality of subscriber terminals 106. The primary ISP 102 (i.e., the primary service provider) includes or is joined with a sub-ISP 108, through which the primary ISP 102 provides Internet access to other subscriber terminals 106. Although one sub-ISP 108 is shown, in other example implementations the primary ISP 102 may include or be joined with any number of sub-ISP's. The primary ISP 102 includes a plurality of primary ISP servers 110 through which the primary ISP 102 provides Internet access and in which the primary ISP 102 stores some account information (e.g., subscriber primary account records). The sub-ISP 108 also includes a plurality of servers 112 in which the sub-ISP 108 stores account information (e.g., subscriber primary account records) and through which the sub-ISP 108 provides Internet access. The primary ISP servers 110 and the sub-ISP servers 112 may be located in different geographical locations (e.g., in different local access transport areas (LATA's), municipalities, states, country regions, etc.) and may provide Internet services using different domain names. For example, the domain name of the primary ISP 102 may be @primaryISP.com and the domain name of the sub-ISP 108 may be @subsidiaryprovider.net.

In addition to providing access to the Internet 104, the primary ISP 102 may also provide one or more additional service(s) 114. The additional services 114 may include, for example, web page hosting services, web portal access, online content subscriptions (e.g., e-magazines, financial reports, financial news, music access, etc.), e-mail enhancements, online storage capacity, etc. Each of the additional services 114 may be provided using one or more servers 116 separate from the primary ISP servers 110. The additional service servers 116 may be configured to store software and/or data associated with implementing the additional services and may also store sub-account information associated with subscribers enrolled to use or access the additional services 114.

The primary ISP 102 may also enable third parties to offer third-party services 118 via the network of the primary ISP 102 (i.e., via the communication channels of the primary ISP 102). For example, the primary ISP 102 may form one or more contractual agreements with one or more third parties to provide the third-party services 118 to subscribers of the primary ISP 102 at a discounted price. For example, a third-party service providing online music access (e.g., music downloads, Internet radio, etc.) may be offered to subscribers of the primary ISP 102 for free or at a substantially reduced price as an incentive to purchase Internet service access from the primary ISP 102. The third-party services 118 may alternatively or additionally include online content subscriptions (e.g., financial news or other news of interest), banking features, e-mail features, web hosting capabilities, video media services (e.g., Internet protocol television (IPTV), video downloads, etc.), file sharing capabilities, message board services, etc. Some of the third-party services 118 may be similar to the additional services 114.

In the illustrated example of FIG. 1, the primary ISP 102 may store software, data, and/or sub-account subscriber information associated with the third-party services 118 in internal third-party servers 120 which are communicatively connected to the primary ISP servers 110. For example, the servers 120 and the primary ISP servers 110 may be directly connected via one or more connections. Alternatively or additionally, external third-party servers 122 used to store software, data, and/or sub-account subscriber information associated with the third-party services 118 may be communicatively coupled to the primary ISP servers 110 via the Internet 104.

As described in greater detail below, the example fraud detector 202 of FIG. 2 may be used to monitor Internet activity information including account and sub-account information associated with obtaining services from the primary ISP 102, the additional services 114, and/or the third-party service 118. The fraud detector 202 may also be configured to monitor Internet access information associated with accessing any other Internet-accessible information 124 (e.g., media files, message board information, banking information, on-line retailer information, etc.). In any case, the fraud detector 202 detects fraud by comparing network abuse patterns with the Internet services activity information.

As shown in FIG. 2, the example fraud detector 202 is communicatively coupled to a plurality of data storage devices (e.g., databases, data structures, etc.). To obtain ISP account information, the example fraud detector 202 is communicatively coupled to one or more ISP subscriber enrollment data structure(s) 204. The ISP subscriber enrollment data structures 204 may store, for example, subscriber names, addresses, telephone numbers, credit card information, Internet protocol (IP) address, etc. In the illustrated example, the ISP subscriber enrollment data structures 204 include a primary ISP data structure and sub-ISP data structures. The primary ISP data structure may be stored in the primary ISP servers 110 of FIG. 1 and the sub-ISP data structures may be stored in the sub-ISP servers 112 of FIG. 1.

To obtain sub-account information associated with the one or more additional service(s) 114 of FIG. 1 provided by the primary ISP 102 of FIG. 1, the fraud detector 202 is communicatively coupled to one or more additional services subscriber enrollment data structure(s) 206. To obtain sub-account information associated with the third-party services 118 of FIG. 1, the fraud detector 202 is communicatively coupled to one or more third-party services subscriber enrollment data structure(s) 208. The additional services subscriber enrollment data structures 206 and the third-party services subscriber enrollment data structures 208 may include types of information substantially similar or identical to the types of information stored in the ISP subscriber enrollment data structures 204. For example, an ISP subscriber electing to signup for one of the additional services 114 or third-party services 118 of FIG. 1 may be required to provide a name, address, and credit card number to enroll in the additional service. Alternatively, the ISP subscriber may merely be required to provide a user login name or similar information identifying the ISP subscriber as subscribed to receive Internet access from the primary ISP 102 (or the sub-ISP 108). Consequently, the additional services servers 116 (FIG. 1) and/or the third-party services servers 120, 122 (FIG. 1) may retrieve or point to enrollment information in the ISP subscriber's account information stored in the ISP subscriber enrollment data structures 204.

To track or monitor network abuse history, the fraud detector 202 is communicatively coupled to a fraud and abuse history data structure 210. For each detected instance of fraudulent and/or abusive Internet activity, the fraud detector 202 of the illustrated example creates a data record in the fraud and abuse history data structure 210 to store information describing the detected network abuse. The data records may include, for example, names, addresses, telephone numbers, IP addresses, user names, e-mail addresses, etc. associated with accounts or sub-accounts that have been identified in connection with a network abuse event.

The example fraud detector 202 of the illustrated example uses the information stored in the fraud and abuse history data structure 210 to detect subsequent fraudulent and/or activity. For instance, the fraud detector 202 may compare subsequently obtained Internet activity information with the information stored in the fraud and abuse history data structure 210 to determine whether, for example, account information previously identified in connection with fraudulent and/or Internet activity is subsequently used in connection with another account or sub-account. If so, the fraud detector 202 can flag the obtained Internet activity information as associated with suspicious activity.

To store patterns of network abuse, the fraud detector 202 of the illustrated example is communicatively coupled to a fraud and abuse pattern data structure 212. The data structure 212 may store a plurality of patterns in the fraud and abuse pattern data structure 212 including patterns related to different types of network abuse. The fraud detector 202 may compare account information and Internet activity information with the pattern data stored in the fraud and abuse pattern data structure 212 to determine whether particular subscriber accounts are suspected of network abuse. For example, some patterns may be based on fraudulent and/or activities of specific individuals or entities. Some patterns may indicate typical or general characteristics of account hopping, e-mail spamming, posting copyrighted, protected, or other unlawful information. For example, some patterns may indicate combinations of characters (e.g., character combinations that include periods “.”, hyphens “-”, underscores “_”, etc.) often used in spammer e-mail addresses.

In the illustrated example, the fraud and abuse pattern data structure 212 is used to store one or more IP address ban lists 214 that include IP addresses that have been banned from eligibility from ISP services. For example, the IP addresses in the IP address ban lists 214 may have previously been used to commit network abuse. Also, the IP address ban lists 214 may include IP addresses that an ISP has deemed insecure IP addresses that could create a threat to the ISP network. As also depicted in FIG. 2, the fraud and abuse pattern data structure 212 of the illustrated example is used to store one or more credit card ban lists 216 that include credit card numbers that have been reported stolen or that have previously been used to create accounts involved in network abuse. The fraud detector 202 may compare IP addresses and/or credit card numbers in subscriber accounts with the IP addresses and credit card numbers stored in the IP address ban lists 214 and the credit card ban lists 216 to determine whether subscriber account information is suspicious. Although only the IP address ban lists 214 and the credit card ban lists 216 are illustrated, other lists of suspect information may also be stored in the fraud and abuse pattern data structure 212 such as, for example, suspect phone numbers lists, suspect geographical addresses lists, suspect e-mail addresses lists, suspect bill-to telephone numbers lists, suspect bill account numbers lists, etc. A bill-to telephone number is typically used to bill a subscriber for a plurality of services based on the subscriber's telephone number. A bill account number is typically used to associate a subscriber with a plurality of services (e.g., local phone service, long-distance phone service, Internet access service, wireless telephone/Internet service, etc.).

In some example implementations, the pattern data may be categorized or organized in any other suitable topical or subject matter categories. In this manner, after obtaining Internet activity information, the fraud detector 202 of the illustrated example retrieves the pattern information that pertains to the type of the obtained account or Internet activity information. For example, if the fraud detector 202 of the illustrated example receives account information corresponding to recently created accounts, the fraud detector 202 may retrieve account/sub-account pattern data. Alternatively, if the fraud detector 202 receives e-mail activity information, the fraud detector 202 may obtain e-mail pattern data.

During, for example, initial installation of the fraud detector 202, a user (e.g., a system administrator) may install basic or generic pattern data in the fraud and abuse pattern data structure 212. After each subsequent instance of detected fraudulent and/or activity, the fraud detector 202 of the illustrated example updates and modifies the pattern data and/or a system administrator may install additional pattern data to reflect new patterns. Updating the pattern data based on subsequently detected instances of network abuse ensures that the fraud detector 202 is capable of detecting any evolved or new schemes employed by fraudulent users trying to evade detection.

To obtain one or more terms of one or more third-party service agreements, the fraud detector 202 of the illustrated example is communicatively coupled to one or more third-party service agreements data structures 218. In an example implementation, the primary ISP 102 of FIG. 1 may form contractual agreements with third parties to provide third-party services to ISP subscribers and store service agreements of those third parties in the third-party service agreements data structures 218. The third-party service agreements set forth the terms with which an ISP subscriber wishing to use the third-party services must comply.

Upon receiving historical Internet activity information associated with a third-party service, the fraud detector 202 of the illustrated example can retrieve the terms of the corresponding service agreement stored in the third-party service agreements data structures 218 and compare each of the retrieved terms with the received Internet activity information. The fraud detector 202 can mark the Internet activity information as suspect if, based on the comparison, it determines that any of the service agreement terms have been violated. Additionally or alternatively, each third-party may use its own service agreement violation detection technique(s) to determine whether an ISP subscriber is violating any term(s) of its service agreement. To store and/or retrieve data indicative of one or more service agreement violations, the fraud detector 202 of the illustrated example is communicatively coupled to a third-party service agreement violations data structure 220. For each detected violation of a service agreement term, the fraud detector 202 and/or a third-party may create a data record in the third-party service agreement violations data structure 220 to store information describing the detected violation. The fraud detector 202 may subsequently retrieve the data records from the third-party service agreement violations data structure 220 to implement preventative and/or corrective action.

To determine the validity of ISP subscriber addresses and information stored in the ISP subscriber enrollment data structures 204, the fraud detector 202 of the illustrated example is communicatively coupled to a federal postal service address data structure 222. In an example implementation, the federal postal service address data structure 222 stores all of the street addresses recognized by a country's postal service and may also store the names of addressees associated with the street addresses. The fraud detector 202 may compare the addresses and names stored in the federal postal service address data structure 222 to the street address and subscriber name for each account stored in the ISP subscriber enrollment data structures 204. The fraud detector 202 may flag an account as suspect if it determines that the street address and/or subscriber name of the account do not exist in the federal postal service address data structure 222 and/or if the name and address entries stored in the federal postal service address data structure 222 do not indicate that the account name and address correspond to one another.

To determine the validity of ISP subscriber information and addresses stored in the ISP subscriber enrollment data structures 204, the fraud detector 202 of the illustrated example is also communicatively coupled to a regional Internet registry (RIR) data structure 224. The RIR data structure 224 is an entity that administrates Internet resources such as the allocation and registration of IP addresses. A plurality of RIR's operate throughout the world, each of which is responsible for a specific world region in which it administrates Internet resources. RIR's throughout the world include the American Registry for Internet Numbers (ARIN), the African Network Information Center (AfriNIC), the Asia Pacific Network Information Centre (APNIC), the Latin American Caribbean IP Address Regional Registry (LACNIC), and the Reseaux IP Europeens Network Coordination Centre (RIPE NCC). In an example implementation, to verify the validity of a subscriber address stored in the ISP subscriber enrollment data structures 204, the fraud detector 202 may identify the region of the world corresponding to the address (e.g., United States is the region of the world for an address indicating the United States, Africa is the region of the world for an address indicating any of the African nations, etc.) and determine whether the IP address of the subscriber corresponds to the identified region of the world. Specifically, the fraud detector 202 may compare the IP address or a portion thereof (e.g., the higher order numbers forming an IP address prefix such as, for example, 253.125.xxx.xxx) to IP numbers or IP address prefixes stored in the RIR data structure 224. Although one RIR data structure is shown, the fraud detector 202 may be communicatively coupled to any number of RIR data structures, each of which may include information resource information (e.g., IP addresses) corresponding to one or more different world regions.

To prevent or stop abusive or fraudulent activity, the fraud detector 202 of the illustrated example is communicatively coupled to a plurality of ISP resources that may be used to implement different approaches to responding to the abusive or fraudulent activity. Some responsive actions may include sending warning or informational e-mails to a subscriber suspected of abuse or fraud, displaying warnings via a web page, resetting passwords, confronting the subscriber via customer service calls (e.g., calls initiated by the subscriber or the ISP), etc.

In the illustrated example, the fraud detector 202 is communicatively coupled to an e-mail server 230 to cause the e-mail server 230 to send e-mails to ISP subscribers suspected of participating in fraudulent and/or Internet activity. The e-mails may include specific information pertaining to the identified fraudulent and/or activity with a message requesting the ISP subscriber to stop any further inappropriate activity. Additionally or alternatively, the message may instruct the ISP subscriber to call the ISP's customer service number.

To display messages via web pages to ISP subscribers suspected of participating in fraudulent and/or Internet activity, the fraud detector 202 is also communicatively coupled to a web page server 232. In an example implementation, the fraud detector 202 may instruct the web page server 232 to display information pertaining to the suspected fraudulent and/or activity via a web page in response to a user logging in to an ISP service. The displayed information may include a warning and/or may include instructions directing the ISP subscriber to contact the ISP's customer service number.

To reset ISP subscriber passwords, the fraud detector 202 is communicatively coupled to a password reset system 234. In an example implementation, the fraud detector 202 may reset passwords of ISP subscribers suspected of participating in fraudulent and/or Internet activity. In some instances, the fraud detector 202 may first send the suspected ISP subscribers warnings via the e-mail server 230 or the web page server 232 as described above informing the subscribers of possible password resets unless the detected fraudulent and/or activity is remedied. The ISP provider may additionally or alternatively reset passwords to motivate the subscriber to contact the ISP customer service department. In this manner, the customer service department can address the suspect activity directly with the subscriber in real-time.

To configure the manners in which some or all of the above-described information is managed, the fraud detector 202 is communicatively coupled to a customer relationship management (CRM) system 238. The CRM system 238 provides a user interface via which users (e.g., system administrators) can select how the fraud detector 202 operates and how the information associated with detecting network abuse is managed. For example, a user may use the CRM user interface to set alarms or alerts for suspected fraudulent and/or Internet activity. In some example implementations, the alarms may be set for assertion in response to some types of detected activity. Additionally or alternatively, users can use the CRM interface to set threshold values (e.g., a minimum number of consecutively created e-mail addresses per ISP subscriber account, severity of violations, quantity of violations per account, etc.) that will cause generation of an alarm. Also, a user may select the type(s) of alarm(s) to be generated. For example, an alarm may be implemented as an indicator on a monitor screen visible to a user after logging into the CRM system 238. Alternatively or additionally, an alarm may be delivered via e-mail, pager, phone call, short messaging service (SMS), etc. to, for example, one or more ISP system administrators.

In the illustrated example, the CRM system 238 is also used to manage the information stored in some or all of the data structures (e.g., the data structures 204, 206, 208, 210, 212, 218, and 220) described above. For instance, the CRM system 238 may create and modify account information in the ISP subscriber enrollment data structures 204 and the shared services subscriber enrollment data structures 206. For each detected instance of suspect Internet activity, the fraud detector 202 may forward information identifying the detected activity and ISP account to the CRM system 238, and the CRM system 238 may in turn set a suspect flag (e.g., a term(s) of service violations flag) in the account corresponding to the offending ISP subscriber in the ISP subscriber enrollment data structures 204, the shared services subscriber enrollment data structures 206, and/or the third-party service agreement violations data structure 220.

In the illustrated example, the CRM system 238 includes an abuse response handler (not shown) that provides ISP customer service representatives with information pertaining to offending ISP subscribers when the offending ISP subscriber contacts (e.g., via e-mail, call, on-line chat help, etc.) the ISP customer service department. In this manner, ISP customer service representatives are enabled to effectively interact with the offending ISP subscriber to remedy the problem. In some example implementations, when an ISP subscriber calls the ISP customer service and provides an account number, the CRM system 238 uses the account number to retrieve account information including any information pertaining to fraudulent and/or activity and provides the retrieved information to an ISP customer service representative handling the subscriber's call.

The CRM system 238 of the illustrated example may also be configured to manage the operations pertaining to the e-mail server 230, the web page server 232, and/or the password reset system 234 described above. For example, the CRM system 238 may employ user-selected parameter information (e.g., alarm types, activity for which alarms should be generated, abusive and fraudulent activity threshold values, etc.) to analyze network abuse activity reports generated by the fraud detector 202 to determine whether to implement corrective or preventative actions. The CRM system 238 may then instruct any one or more of the e-mail server 230, the web page server 232, or the password reset system 234 to implement the remedying action (e.g., send an e-mail to the offending subscriber, display a message via a web page to the offending subscriber, reset the offending subscriber's password, etc.).

In the illustrated example, to automatically handle customer service calls made by ISP subscribers, the fraud detector 202 and the CRM system 238 are communicatively coupled to an interactive voice response (IVR) system 240. The fraud detector 202 and/or the CRM system 238 of the illustrated example may communicate instructions to the IVR system 240 informing the IVR system 240 how to handle calls from particular suspect ISP subscribers. For example, when a subscriber suspected of fraudulent and/or activity calls the IVR system 240 and is identified by the IVR system 240 (e.g., the user provides an account number or the IVR system 240 determines a phone number via caller ID), the CRM system 238 may retrieve any information in the subscribers' account record(s) indicating suspect activity and communicate that information to the IVR system 240. The IVR system 240 may then playback a pre-recorded message to the calling subscriber alerting the subscriber of the suspect activity or account status, and/or the IVR system 240 may transfer the subscriber call to a customer service representative for human interaction. In some example, implementations, the IVR system 240 may include an abuse response handler such that the IVR system 240 may handle calls from suspect subscribers without requiring prompting or instructions from the CRM system 238.

Although the elements illustrated in FIG. 2 are described above as being communicatively coupled to the fraud detector 202 in a particular configuration, it should be understood that the above description and the illustration of FIG. 2 are presented by way of example. Further, in alternative configurations, and to implement some the example methods described herein, it should be understood that although not shown in FIG. 2 some elements are communicatively coupled to other elements such that information may be communicated directly between the elements via a communication medium (e.g., a LAN, a bus, a wireless LAN, a WAN, etc.). For example, although not shown in FIG. 2, the CRM system 238 may be communicatively coupled to the subscriber enrollment data structures 204, 206, 208 and/or to one or more of the other data structures 210, 212, 218, 220, 222, and 224 described above.

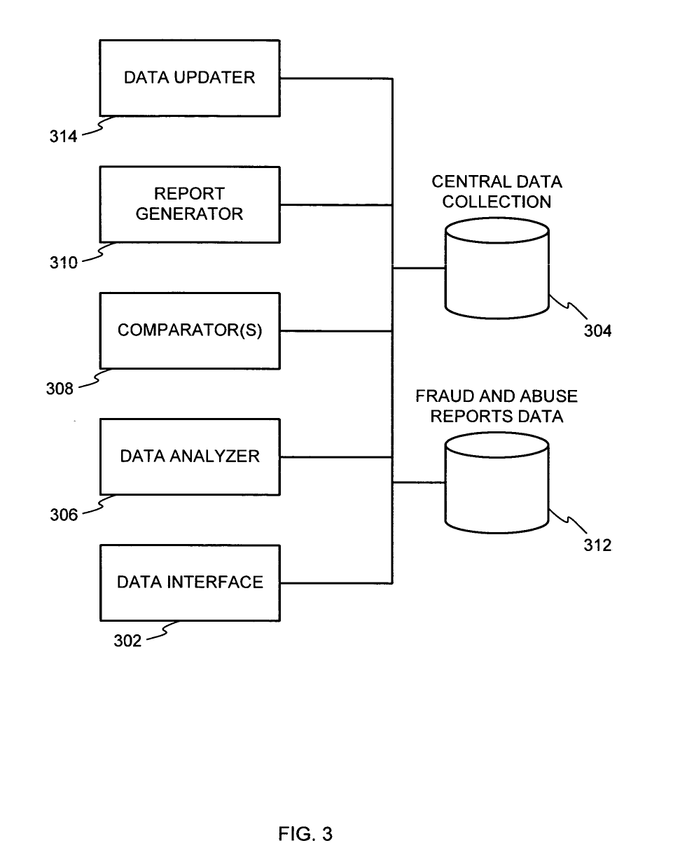

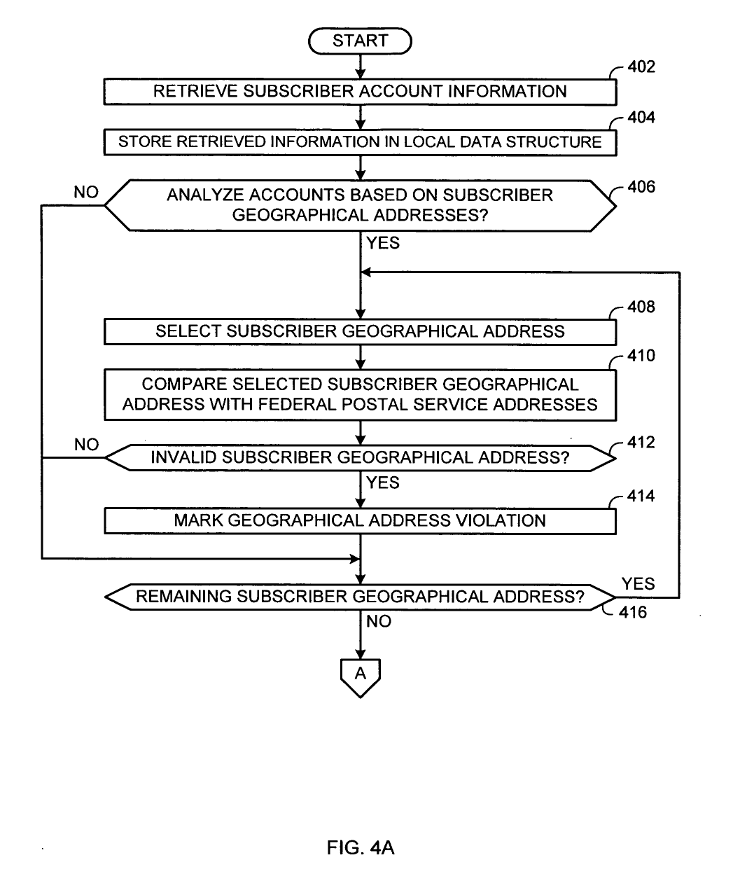

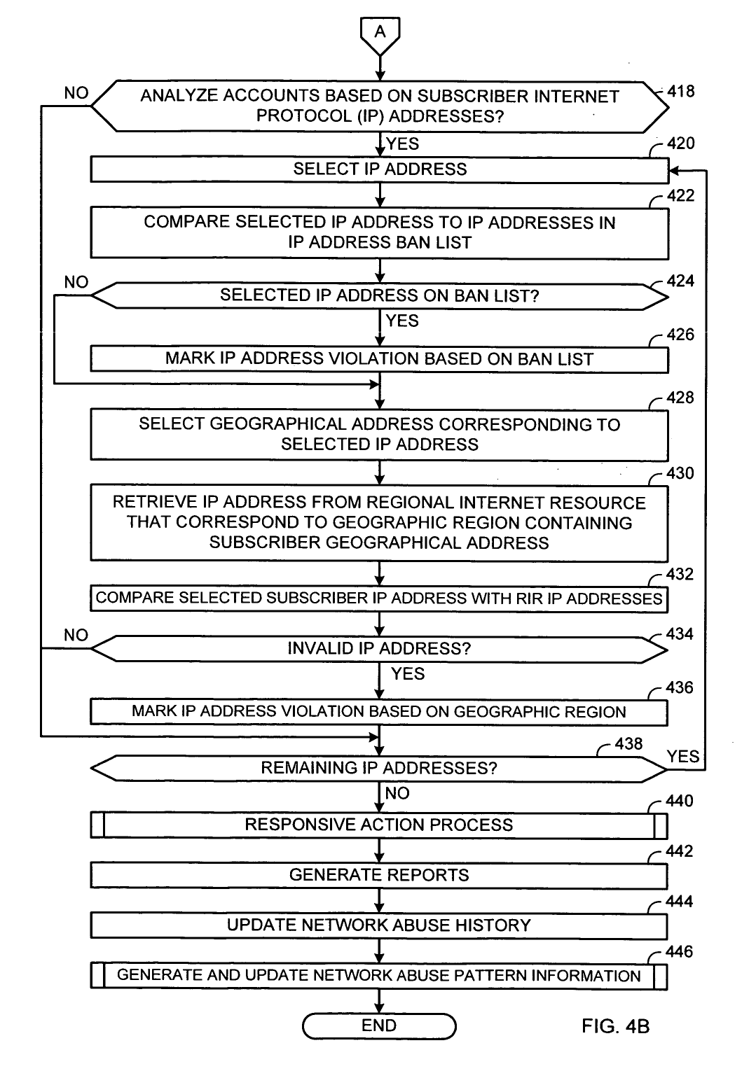

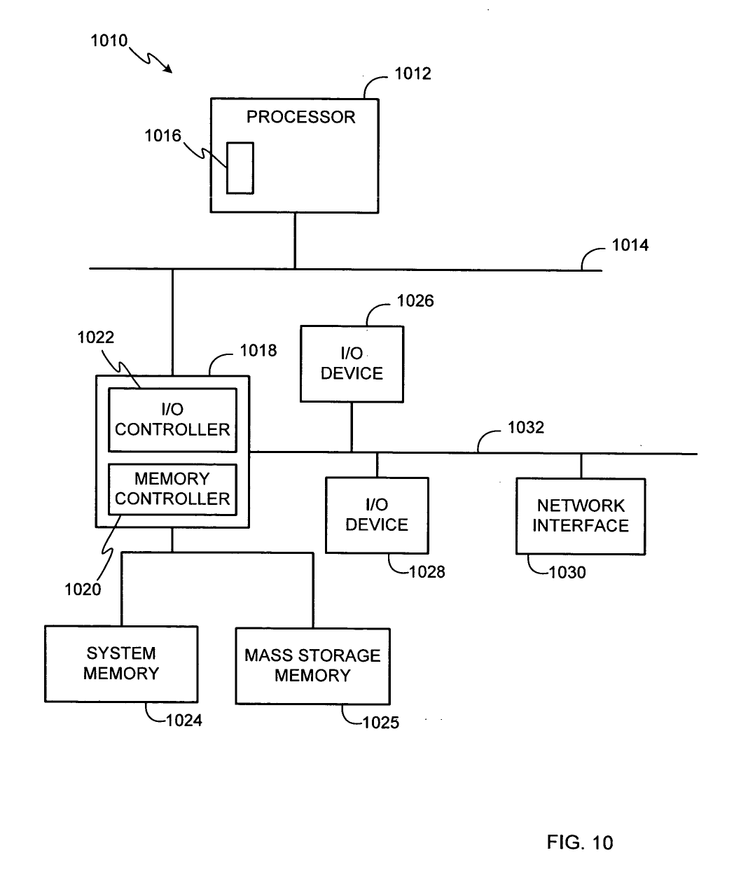

FIG. 3 is a detailed block diagram of the example fraud detector 202 of FIG. 2. The fraud detector 202 may be implemented using any desired combination of hardware, firmware, and/or software. For example, one or more integrated circuits, discrete semiconductor components, or passive electronic components may be used. Additionally or alternatively, some or all of the blocks of the example fraud detector 202, or parts thereof, may be implemented using instructions, code, and/or other software and/or firmware, etc. stored on a machine accessible medium that, when executed by, for example, a processor system (e.g., the example processor system 1010 of FIG. 10), perform the operations represented in the flow diagrams of FIGS. 4A, 4B, and 5-9.

The example fraud detector 202 of FIG. 3 includes an example data interface 302. In the illustrated example, the example data interface 302 obtains Internet activity information (e.g., account information, sub-account information, historical user activity, historical e-mail activity, etc.) from, for example, the data structures 204, 206, 208, and 220 of FIG. 2. To analyze subscriber information for network abuse, the data interface 302 may obtain information from various locations to use during analysis of subscriber Internet activity. For example, the example data interface 302 obtains network abuse history information and pattern information from respective ones of the fraud and abuse history data structure 210 and the fraud and abuse pattern data structure 212 of FIG. 2. In addition, the data interface 302 may obtain service agreements from the third-party service agreement data structures 218 (FIG. 2) and/or from an ISP data structure (not shown) storing ISP service agreements. The example data interface 302 may also retrieve address information from the federal postal service address data structure 222 and/or Internet resource information (e.g., IP addresses and associated geographical location identifiers) from the RIR data structure 224 of FIG. 2.

The example fraud detector 202 of FIG. 3 may also use the data interface 302 to store and/or change information stored in the fraud and abuse history data structure 210 and the fraud and abuse pattern data structure 212 based on detected fraudulent and/or activity. In addition, the data interface 302 may be used to communicate instructions, messages, and/or other information to the e-mail server 230, the web page server 232, the password system 234, the CRM system 238, and/or the IVR system 240 of FIG. 2 in response to detecting network abuse.

To store information obtained via the data interface 302, the fraud detector 202 includes a central data collection data structure 304. In the illustrated example, the fraud detector 202 may use the central data collection data structure 304 as a pseudo-cache structure to store retrieved information on which the fraud detector 202 subsequently performs network abuse detection analyses. In this manner, the fraud detector 202 may employ the data interface 302 to retrieve information that is dispersed throughout various servers (e.g., the servers described above in connection with FIG. 1) in different geographical and/or network locations, and to store the information locally in the central data collection data structure 304 to enable quick access to the information while performing analysis.

To analyze subscriber account information and/or subscriber Internet activity, the fraud detector 202 of the illustrated example includes a data analyzer 306. The data analyzer 306 of the illustrated example retrieves subscriber account information and Internet activity information from the central data collection data structure 304 and/or directly from other data structures described above in connection with FIG. 2. In the illustrated example, the data analyzer 306 is configured to inspect subscriber account information (e.g., names, addresses, telephone numbers, etc.) to determine whether there is any fraudulent information. For example, the data analyzer 306 may use information retrieved from the fraud and abuse history and pattern data structures 210 and 212, the federal postal service address data structure 222 and/or the RIR data structure 224 (FIG. 2) to detect whether any of the subscriber account information includes fraudulent information.

The fraud detector 202 of the illustrated example also uses the data analyzer 306 to determine whether any subscriber account information or Internet activity has violated any service agreement(s) (e.g., primary ISP service agreement(s) or third-party service agreement(s)) by comparing each term of each applicable service agreement with the account information and Internet activity information of each ISP subscriber.

The fraud detector 202 of the illustrated example also includes one or more comparators 308. The comparators 308 may include a comparator for detecting fraudulent and/or activity, a comparator for determining when instances of suspect activity have exceeded minimum threshold values (e.g., mass e-mails from an account have exceeded a maximum e-mail quantity threshold), a geographical address comparator to compare ISP subscriber addresses with addresses retrieved from the federal postal service address data structure 222, an IP address comparator to compare subscriber IP addresses with IP addresses retrieved from the RIR data structure 224, etc. In some example implementations, the comparators 308 may be implemented using one configurable comparator that receives instructions indicative of how to perform comparisons and the type of information on which to perform the comparisons. The comparators 308 may retrieve subscriber account information and Internet activity information from the central data collection data structure 304 and/or directly from other data structures described above in connection with FIG. 2.

The fraud detector 202 of the illustrated example uses the comparators 308 to perform some of the operations otherwise performed by the data analyzer 306 to, for example, accelerate the performance of the data analyzer 306. For example, the fraud detector 202 may use the comparators 308 in addition to, or instead of, the data analyzer 306 to compare one or more service agreement term(s) with account information and Internet activity information to detect a service agreement violation.

To generate reports associated with suspect subscriber account information or Internet activity, the fraud detector 202 of the illustrated example includes a report generator 310. The report generator 310 may generate analysis reports based on the results generated by the data analyzer 306 and/or the comparators 308, and may store the reports in a fraud and abuse reports data structure 312. A user may select the type(s) of reports to be generated via a user interface of the CRM system 238 described above in connection with FIG. 2 and/or may retrieve the reports from the reports data structure 312 via the CRM user interface. Additionally or alternatively, the CRM system 238 may use automated processes to generate alarms and/or warning messages (e.g., warning messages to ISP system administrators, to ISP subscribers, etc. via e-mail, web page, phone, pager, SMS, etc.) based on user-defined configurations indicative of the types of fraudulent and/or activities for which to generate alarms, the user-defined threshold values, and the types of mediums (e.g., e-mail, web page alert indicator, pager, phone, etc.) for the alarms.

In some example implementations, the CRM system 238 uses the data analyzer 306 and/or the comparators 308 to determine when to generate alarms for detected fraudulent and/or activities. For example, the CRM system 238 may communicate user-defined threshold values defining a quantity of fraudulent and/or activity instances required before generating an alarm or alert. The data analyzer 306 and/or the comparators 308 may then compare the user-defined threshold values to analysis reports stored in the fraud and abuse reports data structure 312. An alarm is generated when, for example, a threshold is exceeded.

In the illustrated example, the data analyzer 306 and/or the report generator 310 of the illustrated example generate network abuse pattern information to update the pattern information stored in the fraud and abuse pattern data structure 212 described above in connection with FIG. 2.

To update information stored in data structures external to the fraud detector 202, the fraud detector 202 of the illustrated example is provided with a data updater 314. For example, the fraud detector 202 of the illustrated example uses the data updater 314 to update information stored in the fraud and abuse history data structure 210, the fraud and abuse pattern data structure 212, the third-party service agreement violations data structure 220, and/or in one or more of the subscriber account data records described above in connection with FIG. 2. For example, the data updater 314 may store analyses results from network abuse reports in the fraud and abuse history data structure 210. Also, the data updater 314 may update the pattern information in the fraud and abuse pattern data structure 212 based on pattern information generated by the data analyzer 306 and/or the report generator 310. In addition, the data updater 314 may set violation flags in the third-party service agreement violations data structure 220 and/or in subscriber account records in the ISP subscriber enrollment data structures 204 of FIG. 2.

Flowcharts representative of example machine readable instructions for implementing the example fraud detector 202 of FIGS. 2 and 3 and/or other apparatus (e.g., the e-mail server 230, the web page server 232, the password reset system 234, the CRM system 238, the IVR system 240 of FIG. 2) communicatively coupled thereto are shown in FIGS. 4A, 4B, and 5-9. In these examples, the machine readable instructions comprise one or more programs for execution by one or more processors such as the processor 1012 shown in the example processor system 1010 of FIG. 10. The programs may be embodied in software stored on tangible mediums such as CD-ROM's, floppy disks, hard drives, digital versatile disks (DVD's), or a memory associated with the processor 1012 and/or embodied in firmware and/or dedicated hardware in a well-known manner. For example, any or all of the fraud detector 202, the data interface 302, the central data collection data structure 304, the data analyzer 306, the comparators 308, the report generator 310, the fraud and abuse data structure 312, and/or the data updater 314 could be implemented using software, hardware, and/or firmware. Further, although the example program is described with reference to the flowcharts illustrated in FIGS. 4A, 4B, and 5-9, persons of ordinary skill in the art will readily appreciate that many other methods of implementing the example fraud detector 202 and other apparatus communicatively coupled thereto may alternatively be used. For example, the order of execution of the blocks may be changed, and/or some of the blocks described may be changed, eliminated, or combined.

As shown in FIG. 4A, initially the data interface 302 (FIG. 3) retrieves subscriber account information (block 402). In the illustrated example, the subscriber account information may include a plurality of subscriber account data records that contain, for example, names, addresses, phone numbers, IP addresses, etc. In the illustrated example, the data interface 302 retrieves the subscriber account information from a plurality of network nodes having storage locations communicatively coupled to an ISP's network. For example, the data interface 302 may retrieve the account information from one or more of the ISP subscriber enrollment data structures 204 of FIG. 2 (e.g., primary-ISP and sub-ISP accounts), the shared services subscribers enrollment data structures 206 of FIG. 2, or the third-party services subscriber enrollment data 208 of FIG. 2. In some example implementations, the data interface 302 retrieves the subscriber account information in groups categorized by address (e.g., subscriber account information grouped by addresses having common cities or zip codes). In this manner, the fraud detector 202 can analyze the subscriber account information by geographic region.

The data interface 302 of the illustrated example stores the retrieved subscriber account information in a local data structure (block 404) such as, for example, the central data collection data structure 304 of FIG. 3. In this manner, other portions (e.g., the data analyzer 306, the comparators 308, the report generator 310, and/or the data updater 314 of FIG. 3) of the fraud detector 202 can relatively quickly access the subscriber account information from a local storage area during network abuse analyses instead of having to repeatedly access remotely located storage data structures. Accesses local data is advantageous because accessing remote data structures may create lengthy delays due to, for example, network congestion, required communication control and overhead data (e.g., network packet headers, security encryption data, handshaking, Cyclic Redundancy Check (CRC) data, etc.), etc.

The fraud detector 202 of the illustrated example next determines whether to analyze subscriber account records based on subscriber geographical addresses (block 406). For example, the retrieved subscriber account information may pertain to accounts for which the geographical addresses have not yet been verified to determine whether the addresses are valid (e.g., phony addresses or real addresses). In this case, the fraud detector 202 of the illustrated example determines that it should analyze the subscriber account information based on the subscriber geographical address information. Alternatively, the retrieved subscriber account information may correspond to accounts for which the geographical addresses have already been analyzed and verified. In which case, the fraud detector 202 of the illustrated example determines that it should not analyze the subscriber geographical addresses (block 406).

If the fraud detector 202 of the illustrated example determines at block 406 that it should analyze the subscriber account information based on the subscriber geographical addresses, one of the comparators 308 selects one of the subscriber geographical addresses (block 408) and compares the selected subscriber geographical address with addresses stored in the federal postal service address data structure 222 (FIG. 2) (block 410). In some example implementations, the data interface 302 retrieves groups of addresses (e.g., addresses grouped by city or zip code) from the federal postal service address data structure 222 and stores the addresses in the central data collection data structure 304 for local access by the comparators 308 during analysis of the subscriber geographical address information.

The comparator 308 then determines whether the selected subscriber geographical address is invalid (block 412). A subscriber geographical address may be invalid if it does not exist (e.g., is false information, incorrect combination of street name, city name, and/or state) in the federal postal service address data structure 222. If the comparator 308 determines that the subscriber geographical address is invalid (block 412), then the comparator 308 causes the subscriber account corresponding to the selected geographical address to be marked as being in violation (block 414). For example, the comparator 308 may output a “no match” or “false” signal that causes the data updater 314 to flag the subscriber account record corresponding to the invalid geographical address with an invalid bit. The data updater 314 may flag the subscriber account record in the central data collection data structure 304 and/or in the original storage location (e.g., one of the data structures 204, 206, or 208 (FIG. 2) communicatively coupled to the fraud detector 202 from which the data interface 302 retrieved the subscriber account information.

If at block 406, the fraud detector 202 determines that it should not analyze the subscriber geographical address information of the subscriber account information retrieved by the data interface 302 and stored in the central data collection data structure 304, or, if the comparator 308 determines at block 412 that the selected subscriber geographical address is not invalid, or, after the data updater 314 marks a subscriber account data record as having an invalid geographical address, the fraud detector 202 then determines if there are any remaining subscriber geographical addresses to be analyzed (block 416). If there are any remaining subscriber geographical addresses in the central data collection data structure 304 to be analyzed, control is returned to block 408 and the comparator 308 selects another subscriber geographical address. Otherwise, control is passed to block 418 of FIG. 4B.

As shown in FIG. 4B, the fraud detector 202 determines whether it should analyze the subscriber account records based on the subscriber Internet protocol (IP) addresses (block 418). The ISP may detect the IP address of a subscriber during initial ISP service enrollment based on the subscriber's Internet connection to the ISP services, and the ISP may store the detected IP address in the subscriber's account record. In this manner, the fraud detector 202 may compare the subscriber's IP address with IP addresses on a ban list. Also, the fraud detector 202 can use the subscriber's IP address and geographical address information in connection with IP address and geographical region information retrieved from the RIR data structure 224 (FIG. 2) to determine whether the subscriber's IP address and/or the geographical address are invalid. In some cases, the fraud detector 202 may analyze subscriber IP addresses only once after initial enrollment to an ISP service. In other implementations, the fraud detector 202 may periodically or aperiodically analyze IP addresses.

If the fraud detector 202 determines that it should analyze IP addresses (block 418), then one of the comparators 308 selects an IP address for a first subscriber account record (block 420). The comparator 308 then compares the selected IP address to IP addresses in an IP address ban list (e.g., one of the IP address ban lists 214 of FIG. 2) (block 422). In the illustrated example, the IP address ban list is stored in the fraud and abuse pattern data structure 212 of FIG. 2 and is used to store IP addresses that have been previously involved in fraudulent and/or activity or that are deemed insecure IP addresses, thus causing the IP addresses to be banned from eligibility for ISP services.

The comparator 308 determines if the selected IP address is on the IP address ban list (block 424) by, for example, comparing the selected IP address to IP addresses in the ban list. If the comparator 308 determines at block 424 that the selected IP address is in the ban list, the comparator 308 then causes the selected IP address to be marked in violation based on the IP address ban list (block 426). For example, the comparator 308 may output a “match” or “true” signal that causes the data updater 314 to flag the subscriber account record corresponding to the banned IP address with an invalid bit. The data updater 314 may flag the subscriber account record in the central data collection data structure 304 and/or in the original storage location (e.g., one of the data structures 204, 206, or 208 of FIG. 2) communicatively coupled to the fraud detector 202 from where the data interface 302 retrieved the subscriber account information.

After the IP address is marked (block 426) or if the comparator 308 determines that the selected IP address is not on the IP address ban list (block 424), the data interface 302 retrieves the subscriber geographical address corresponding to the selected IP address (block 428). In the illustrated example, the data interface 302 retrieves the subscriber geographical address from the subscriber account information stored in the central data collection data structure 304 (FIG. 3) and uses the subscriber geographical address to retrieve IP addresses from the RIR data structure 224 (FIG. 2) that the RIR assigned to Internet connections within the geographic region (e.g., a country region, a state, a county, a municipality, etc.) corresponding to the subscriber geographical address (block 430). The data structure 302 may store the RIR IP addresses in the central data collection data structure 304 for retrieval by the comparator 308 in subsequent comparison operations.

The comparator 308 then compares the selected subscriber IP address with the retrieved RIR IP addresses containing the selected subscriber geographical address (block 432). In some example implementations in which the RIR assigns particular address prefixes to particular geographic regions, the comparator 308 may compare only the prefixes of the IP addresses to find a match.

The comparator 308 then determines if the subscriber IP address is invalid (block 434). A subscriber IP address is invalid if the comparator 308 does not find an exact match or, in some cases, a partial match (e.g., matching address prefixes) with one of the IP addresses that the RIR allocated within the geographic region indicated by the subscriber geographical address.

If the comparator 308 determines that the subscriber IP address is invalid (block 434), the comparator 308 causes the subscriber account associated with the selected IP address to be marked as invalid based on the geographic region (block 436). For example, the comparator 308 may output a “no match” or “false” signal that causes the data updater 314 to flag the subscriber account record corresponding to the invalid IP address with an invalid bit or violation bit. The data updater 314 may flag the subscriber account record in the central data collection data structure 304 and/or in the original storage location (e.g., one of the data structures 204, 206, or 208 of FIG. 2) communicatively coupled to the fraud detector 202 from where the data interface 302 retrieved the subscriber account information.

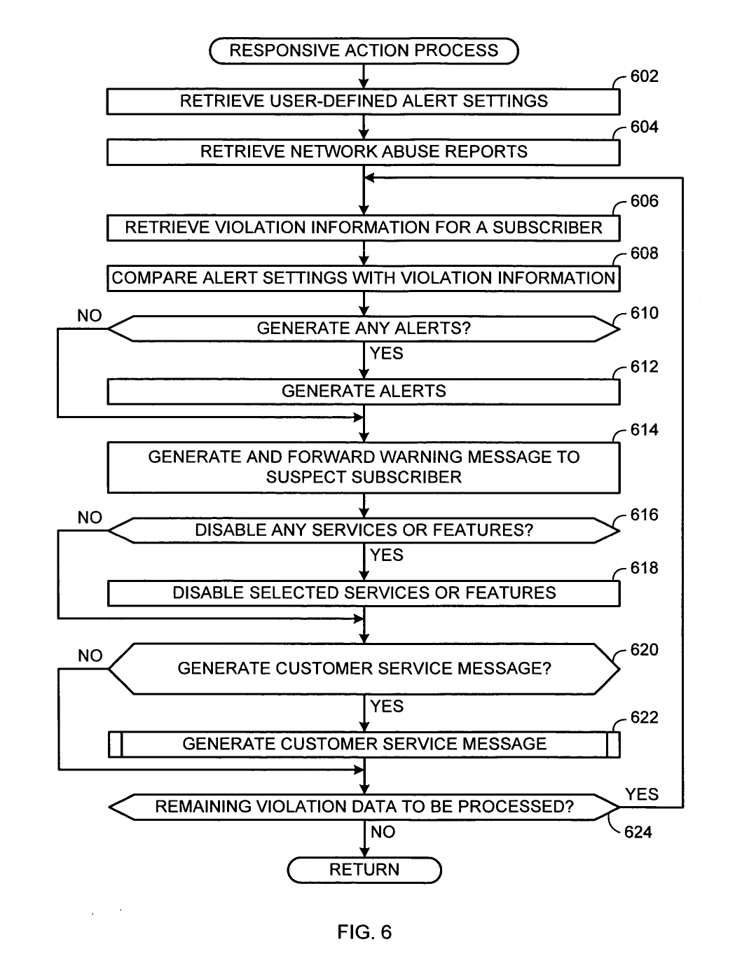

After the comparator 308 causes the subscriber account to be marked as being in violation (block 436), or, if at block 434 the comparator 308 determines that the selected IP address is not invalid, or, if at block 418 the fraud detector 202 determines that it should not analyze the subscriber accounts based on subscriber IP addresses, the fraud detector 202 of the illustrated example determines whether there are any remaining IP addresses to be analyzed (block 438). If there are any remaining IP addresses to be analyzed, then control is returned to block 420 and another IP address is selected for analysis. Otherwise, a responsive action process is executed (block 440). In the illustrated example, the responsive action process (block 440) is executed to implement preventative or remedial action to address any violations identified at block 412, block 424, and/or block 434. An example flowchart representative of machine readable instructions that may be used to implement the responsive action process of block 440 is described below in connection with FIG. 6.

The report generator 310 (FIG. 3) then generates one or more reports (block 442) based on the analyses described above. For example, the report generator 310 may retrieve the invalid flags and corresponding subscriber account information (e.g., names, addresses, IP address, etc.), organize the invalid information and account information in reports, and subsequently store the reports in the fraud and abuse reports data structure 312.

The data updater 314 (FIG. 3) then updates the network abuse history information in the fraud and abuse history data structure 210 (block 444). For example, the data updater 314 may copy some or all of the information stored in the reports in the fraud and abuse reports data structure 312 and store the report information in the fraud and abuse history data structure 210.

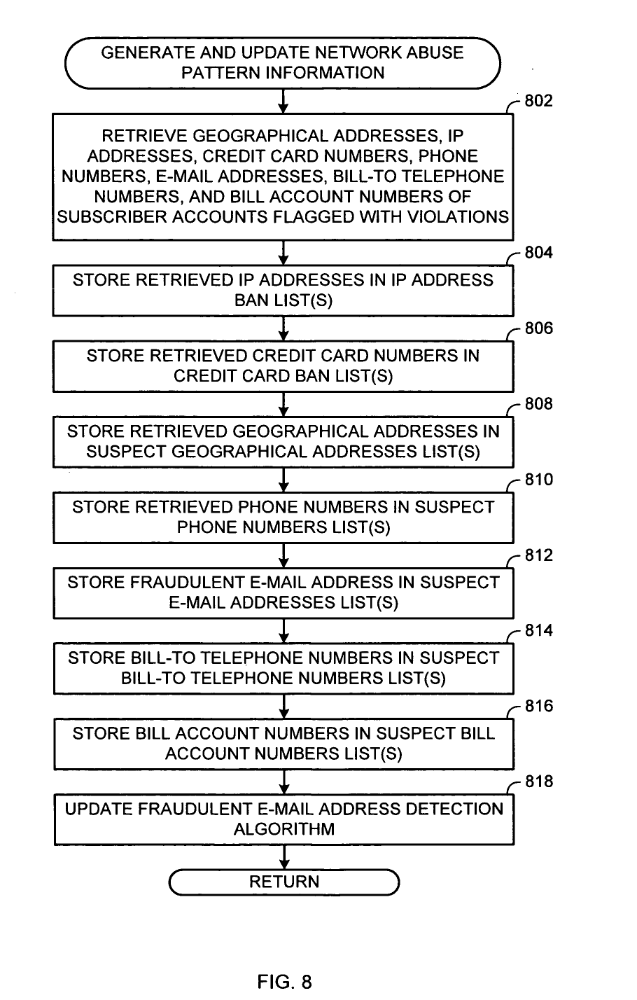

The fraud detector 202 then generates and updates network abuse pattern information (block 446). By generating and updating network abuse pattern information, the fraud detector 202 automatically learns or teaches itself new ways in which to detect fraudulent and abusive activity. For instance, for subscriber accounts found to be in violation, the data updater 314 may place their respective IP addresses on the IP address ban list stored in the fraud and abuse pattern structure 212. In this manner, during subsequent IP address analyses as described above in connection with blocks 422, 424, and 426, the fraud detector may detect banned IP addresses relatively quickly. For example, account hoppers may create many different accounts, but have the same IP address recorded in each account. However, because the IP address is noted in the IP address ban list, the fraud detector 202 will be able to relatively quickly detect and disable those accounts. An example flowchart representative of machine readable instructions that may be used to implement the process of block 446 is described below in connection with FIG. 8. The process of the flowcharts of FIGS. 4A and 4B is then ended.

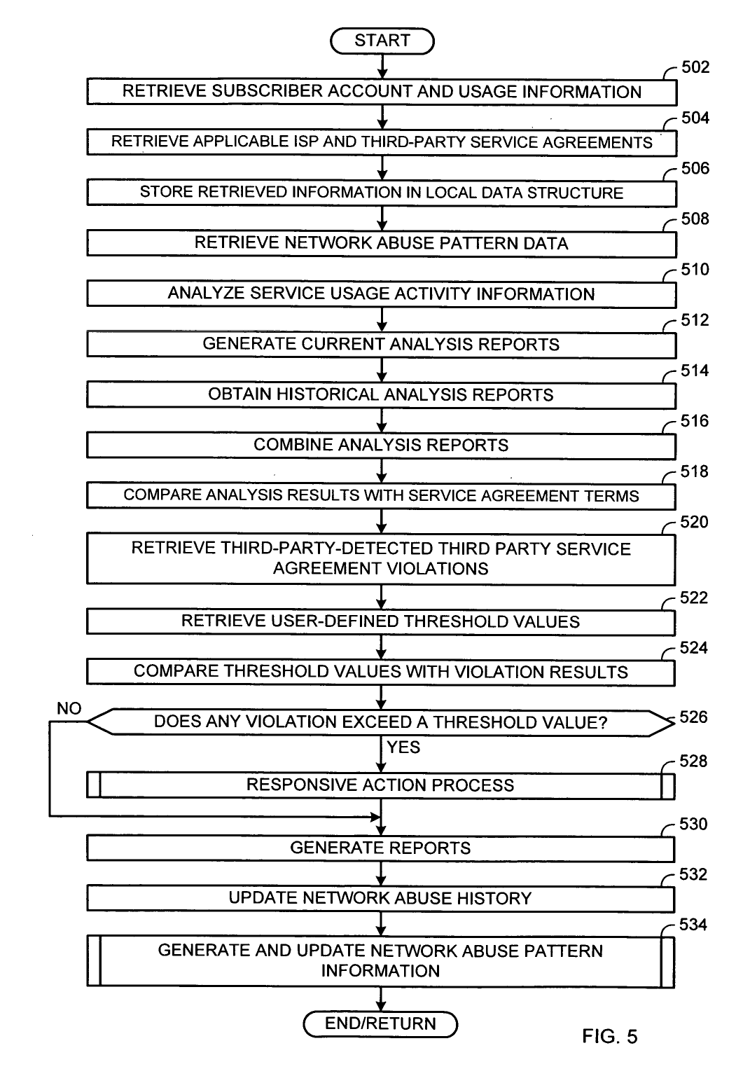

The example flowchart depicted in FIG. 5 is representative of machine readable instructions used to cause the fraud detector 202 of the illustrated example to determine whether ISP subscribers have violated any service agreements. As shown, first the data interface 302 retrieves subscriber account and usage information (block 502). The usage information (e.g., Internet activity information) may include e-mail usage information (e.g., quantities of sent and/or received e-mail per account, indications of harmful e-mail attachments, quantities of e-mail addresses created within particular time duration using the same subscriber account information, etc.), web page serving information (e.g., harmful or banned web page content or hyperlinks, excessive downloads or uploads to web page, etc.), data transfer information (e.g., transferring copyright data, harmful data, banned data, excessively large files, etc.), account information (e.g., e-mail addresses, IP addresses, credit card numbers, etc.), etc. The data interface 302 may retrieve the service usage activity information from various storage locations communicatively coupled to the ISP network including, for example, any one or more of the servers 110, 112, 116, 120, and 122 described above in connection with FIG. 1.

The data interface 302 then retrieves the ISP and/or third-party service agreement(s) applicable to the type of retrieved service usage activity information (block 504). For instance, if at block 502, the data interface 302 retrieved subscriber usage information for one or more subscribers that subscribe to third-party services, then at block 504 the data interface 302 would retrieve the corresponding third-party service agreements. The data interface 302 then stores the retrieved usage information and service agreements in the central data collection data structure 304 (block 506) for access during network abuse analyses.

The data interface 302 of the illustrated example then retrieves network abuse pattern data from the fraud and abuse pattern data structure 212 (FIG. 2) (block 508). In the illustrated example, the network abuse pattern data is retrieved from the fraud and abuse pattern data structure 212 as needed, but in other implementations it may be stored in the central data collection data structure 304 (FIG. 3). The data analyzer 306 then analyzes the subscriber account and usage information (block 510) to extract information of interest such as, for example, quantities of e-mail addresses created within a particular duration of time using the same subscriber account information; quantities of sent and/or received e-mails within a time duration; number of instances that harmful, banned, or copyrighted information was e-mailed, posted on web pages, or transferred via file transfers; types of banned, harmful or copyrighted information that was e-mailed, posted on web pages, or transferred via file transfers; or any other type of information (e.g., subscriber account e-mail addresses, geographic addresses, IP addresses, credit card numbers, etc.) for which a service agreement term exists. In the illustrated example, the data analyzer 306 analyzes the service usage information (block 510) based at least in part on the network abuse pattern data retrieved at block 508. For example, the network abuse pattern data may indicate that e-mail attachments with particular file extensions (e.g., .jpg.exe, .jpg, .js, .lnk, .com, .bat, .do*, etc.) may be harmful. Other pattern information may indicate that sender e-mail addresses containing particular character combinations may pertain to spammer accounts. Of course, other types of network abuse pattern information may be retrieved from the fraud and abuse pattern data structure 212 including, for example, the credit card ban lists 216 of FIG. 2, for use in the analyses of block 510.

The report generator 310 of the illustrated example then generates current analysis reports (block 512) based on the analyses performed by the data analyzer 306 at block 510. The data interface 302 then retrieves historical analysis reports from the fraud and abuse history data structure 210 of FIG. 2 (block 514), and the data analyzer 306 combines the results in the current analysis reports with respective results in the historical analysis reports (block 516) to generate a combined analysis report. In this manner, quantities of usage activity (e.g., quantities of sent/received e-mails) determined at block 510 and stored in current analysis reports can be added to respective quantities of usage activity previously determined for respective subscribers and stored in historical analysis reports. The data analyzer 306 may store the combined analysis report in the central data collection data structure 304 and/or in the fraud and abuse reports data structure 312 for subsequent retrieval.

The comparator 308 of the illustrated example then compares each of analysis result with one or more respective ISP and/or third-party service agreement term(s) (block 518) to determine whether any of the analysis results indicates a violation of the ISP and/or third-party service agreement(s). For example, an analysis result containing a quantity of sent e-mails within a particular time period may indicate that a subscriber violated the service agreement if the e-mail quantity exceeds an e-mail quantity value set forth in a service agreement term.

After the comparator 308 compares the analysis results with the ISP and/or third-party service agreement term(s), the data interface 302 accesses the third-party service agreement violations data structure 220 to retrieve third-party service agreement violations detected by third-party services (block 520). The data interface 302 then retrieves user-defined threshold values (block 522) from, for example, the CRM system 238 (FIG. 2). As described above, the threshold values indicate the quantity of instances or severity of fraudulent and/or abusive activity that will cause the fraud detector 202 and/or the CRM system 328 to implement some responsive action such as, for example, generating alerts or alarms, warning the suspect ISP subscriber, etc. For example, a service agreement violation in the form of an excessively large e-mail attachment may not warrant a responsive action by the ISP even though it technically violated the service agreement. However, multiple instances of large e-mail attachments may warrant responsive action. Another example, which may require immediate ISP responsive action, is detecting a harmful e-mail attachment containing a virus. Thus, the threshold values obtained at block 522 may be set based on quantity (e.g., number of times a particular service agreement has been violated) or severity (e.g., the degree of harm that an e-mail attachment or web page posting is capable of creating) of fraudulent and/or abusive activity.

One of the comparators 308 of the illustrated example then compares the retrieved threshold values with the violations determined at block 518 and the third-party-detected third-party service agreement violation(s) retrieved at block 520 (block 524). The fraud detector 202 then determines whether any of the violations exceeds a threshold value (block 526) based on the comparisons performed at block 526. If the fraud detector 202 determines that any of the violations exceeds a threshold value, then a responsive action process is executed (block 528) by, for example, the fraud detector 202 and/or the CRM system 238 of FIG. 2 as described below in connection with FIG. 6.

After the responsive action process is executed (block 528), or, if at block 526 the fraud detector 202 determines that none of the violations exceed a threshold value, the report generator 310 (FIG. 3) generates one or more reports (block 530). The report generator 310 may generate the one or more reports based on the combined report generated at block 516. In addition, the report generator 310 may include information indicative of any exceeded threshold value(s) detected at block 526 in the reports. In some example implementations, the report generator 310 may generate reports pertaining only to third-party service agreement violations and forward messages including the generated reports to the third-party services 118 (perhaps in exchange for a fee). In this manner, the third-party services 118 can keep informed as to network abuse committed against their services.

The data updater 314 of the illustrated example (FIG. 3) then updates the network abuse history information in the fraud and abuse history data structure 210 (FIG. 2) (block 532) based on, for example, the one or more reports generated at block 530. Additionally, the data updater 314 may update the third-party service agreement violations data structure 220 to include information indicative of any third-party service agreement violation(s) detected at block 510. The fraud detector 202 then generates and updates network abuse pattern information (block 534) as described below in connection with FIG. 8.

The example flowchart depicted in FIG. 6 is representative of machine readable instructions that may be used to execute the example responsive action process of block 440 (FIG. 4B) and block 528 (FIG. 5). The responsive action process depicted in FIG. 6 may be executed by the fraud detector 202, the CRM system 238, and/or any combination thereof. However, for purposes of clarity, the responsive action process is described below as being executed by the CRM system 238. As shown, the CRM system 238 of the illustrated example initially retrieves user-defined alert settings (block 602). The user-defined alert settings can be defined by a user (e.g., a system administrator) via a CRM system graphical user interface. Each of the user-defined alert settings corresponds to a particular type of violation and specifies whether an alert should be generated for that violation type and the type of alert to generate. For example, a user may define that an alert should be generated for violations involving e-mail attachments having viruses. Further, the alert setting may specify whether the alert should be in the form of an e-mail, a pager notification, a user interface screen alert, a phone call, etc. to, for example, the system administrator.

The CRM system 238 then retrieves network abuse reports (block 604). For example, the CRM system 238 may retrieve the network abuse reports from the fraud and abuse reports data structure 312 (FIG. 3) and/or from the fraud and abuse history data structure 210 (FIG. 2). The CRM system 238 then retrieves violation information pertaining to a selected suspect subscriber (block 606) from the retrieved network abuse reports and compares the retrieved alert settings with the retrieved violation information (block 608) and determines whether any alerts should be generated (block 610) based on the comparisons performed at block 608.

If at block 610 the CRM system 238 determines that it should generate one or more alerts, the CRM system 238 generates the one or more alerts (block 612). After the CRM system 238 generates the alerts or if at block 610 the CRM system 238 determines that it should not generate any alerts, the CRM system 238 of the illustrated example generates and forwards a warning message to the suspect subscriber (block 614). The warning message may be displayed via a web page after the subscriber suspected of network abuse logs in to the ISP service. Additionally or alternatively, the warning message may be forwarded via an e-mail to the suspect subscriber or via any other method including a pre-recorded telephone message. In any case, the warning message may indicate to the subscriber that the subscriber's account is in violation of one or more service agreement terms and/or to call the ISP customer service phone number to remedy any action taken by the ISP against the subscriber and/or the subscriber's account.

The CRM system 238 of the illustrated example then determines whether it should disable any services or features (block 616) (e.g., the additional services 114 or the third-party services 118 of FIG. 1). For example, if the network abuse violation is of a sufficiently severe nature (e.g., sending viruses or illegal content via e-mail), the CRM system 238 of the illustrated example may determine that the feature or service pertaining to the violation should be disabled. The CRM system 238 may disable a service or a feature by resetting a subscriber's password to block the subscriber from logging into the service or feature. In some example implementations, the CRM system 238 may determine whether to disable a service or feature based on user-defined threshold values indicating the types of violations that should cause a service or feature to be disabled. For example implementations in which the CRM system 238 disables features or services by resetting passwords, the CRM system 238 may determine to reset only the password(s) pertaining to the services or features for which the subscriber caused the violation.

If at block 616 the CRM system 238 of the illustrated example determines that it should disable one or more services or features, then the CRM system 238 causes the selected one or more services or features to be disabled (block 618). For example, the CRM system 238 may cause the reset password system 234 to reset the subscriber passwords pertaining to the services or features related to the violation.

After the CRM system 238 causes the selected services or features to be disabled, or, if at block 616 the CRM system 238 determines that it should not disable any services or features, the CRM system 238 of the illustrated example determines whether it should generate a customer service response (block 620). In some example implementations, the CRM system 238 may determine whether it should prepare a customer service response based on the severity of the violation(s) and/or user-defined threshold values indicating the conditions under which violations warrant a customer service response. A customer service message includes information that is communicated to customer service agents when the CRM system 238 detects that a suspect subscriber is calling the customer service department. In this manner, the customer service message informs the customer service agents of the type(s) of violation(s) noted in the account of the calling subscriber and enables the customer service agent to handle the call accordingly. Additionally or alternatively, the customer service message may be implemented as a pre-recorded audio message that is played back to the suspect subscriber when the subscriber dials into the IVR system 240 (FIG. 2). The customer services messages may contain information to inform the suspect subscriber of the violations noted in the subscriber's account and to inform the subscriber the manner in which to remedy any action taken against the subscriber and/or the subscriber's account.

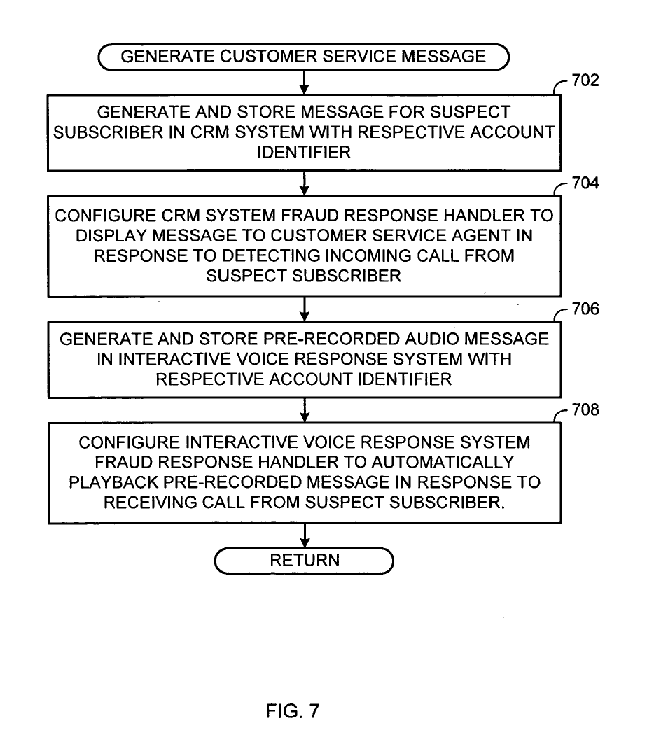

If, at block 620, the CRM system 238 of the illustrated example determines that it should generate a customer service message, the CRM system 238 generates the customer service message (block 622) as described below in connection with FIG. 7. After the CRM system 238 generates the customer service message, or, if at block 620 the CRM system 238 determines that it should not generate a customer service message, the CRM system 238 determines whether there is any remaining violation data to be processed in the retrieved network abuse reports (block 624). If there is some remaining violation data to be processed, then control is passed back to block 606, and the CRM system 238 retrieves violation information for another selected suspect subscriber (block 606). Otherwise, control is returned to, for example, a calling function or process such as the processes implemented using the flowcharts of FIGS. 4A, 4B, and 5.

The flowchart depicted in FIG. 7 is representative of machine readable instructions that may be used to generate a customer service message. In particular, the flowchart of FIG. 7 may be used to implement the process of block 622 described above in connection with FIG. 6. Initially, the CRM system 238 of the illustrated example generates and stores a message directed to a suspect subscriber along with a respective account identifier (e.g., an account number) (block 702). The CRM system 238 then configures its abuse response handler to display the message to a customer service agent in response to detecting an incoming call from the suspect subscriber (block 704). In this manner, if the suspect subscriber elects to speak with a customer service agent upon dialing the customer service phone number, the CRM system 238 will facilitate interaction with the customer by detecting the incoming call to the customer service agent and displaying the message to the agent.

The CRM system 238 of the illustrated example also generates and stores a pre-recorded audio message in the IVR system 240 along with a respective account identifier (block 706). The CRM system 238 then configures an abuse response handler of the IVR system 240 to automatically playback the pre-recorded message in response to receiving an incoming call from the suspect subscriber (block 708). In this manner, the CRM system 238 facilitates interaction between the IVR system 238 and a suspect subscriber. For instance, if the suspect subscriber elects to navigate through the IVR system 240 (e.g., after calling the customer service phone number), the IVR system 240 can playback the pre-recorded message in response to receiving the suspect subscriber's phone call. After the CRM system configures the IVR system 240 to playback the pre-recorded message, control is returned to, for example, a calling function or process such as the process implemented using the flowchart of FIG. 6.

The flowchart depicted in FIG. 8 is representative of machine readable instructions that may be used to generate and update network abuse pattern information. In the illustrated example, the flowchart of FIG. 8 may be used to implement the operations of block 446 (FIG. 4B) and block 534 (FIG. 5) described above. Initially, the data updater 314 of the illustrated example (FIG. 3) retrieves geographical addresses, IP addresses, credit card numbers, phone numbers, e-mail addresses, bill-to telephone numbers, and bill account numbers from subscriber accounts flagged with violations (block 802). For example, the data updater 314 may retrieve the information from the central data collection data structure 304 corresponding to the subscriber accounts that were flagged at blocks 414 (FIG. 4A), block 426 (FIG. 4B), block 436 (FIG. 4B), and block 528 (FIG. 5).

The data updater 314 of the illustrated example then stores the retrieved IP addresses in the IP address ban list(s) 214 of FIG. 2 (block 804), the retrieved credit card numbers in the credit card ban list(s) 216 of FIG. 2 (block 806), the retrieved geographical addresses in one or more suspect geographical addresses list(s) (block 808), the retrieved phone numbers in one or more suspect phone numbers list(s) (block 810), the retrieved e-mail addresses in one or more suspect e-mail addresses list(s) (block 812), the retrieved bill-to telephone numbers in one or more suspect bill-to telephone numbers list(s) (block 814), and the retrieved bill account numbers in one or more suspect bill account numbers list(s) (block 816). The data updater 314 then updates a fraudulent e-mail address detection algorithm (block 818). For example, the fraudulent e-mail address detection algorithm may be used to detect whether particular characters, combinations of characters, or character placements (e.g., a character position within the address) exist within an e-mail address. Control is returned to, for example, a calling function or process such as the processes implemented using the flowcharts of FIGS. 4B and 5.

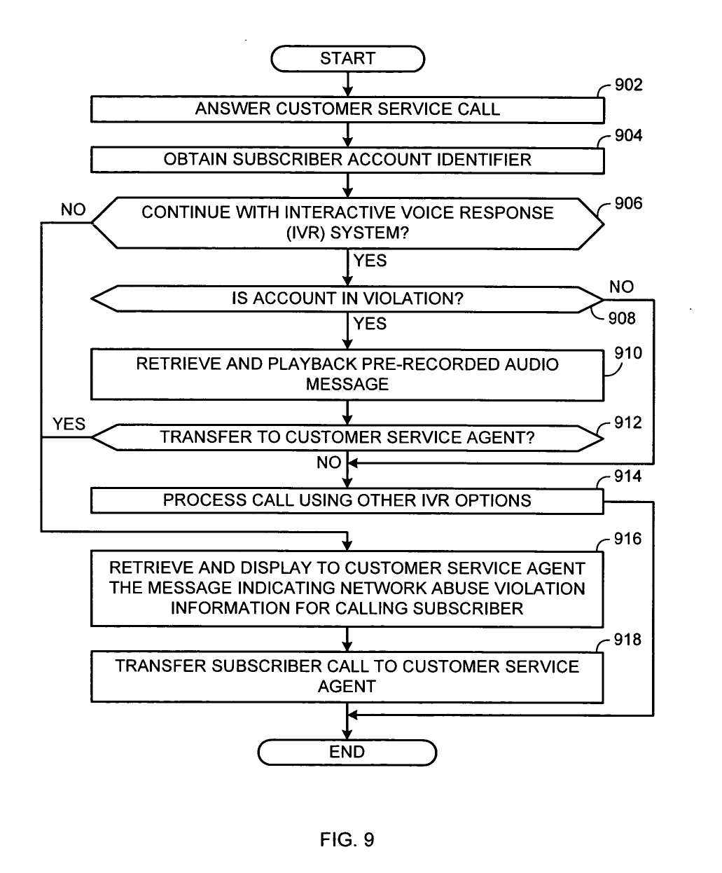

The flowchart depicted in FIG. 9 is representative of machine readable instructions that may be used to implement a customer service responsive action to a suspect subscriber calling the ISP customer service phone number. Initially, the IVR system 240 of the illustrated example answers the customer service call (block 902) and obtains the subscriber account identifier (e.g., an account number) (block 904). For example, the suspect subscriber may provide the subscriber's account identifier by entering it via a phone keypad or by speaking it into the phone. Alternatively, the IVR system 240 may obtain the subscriber account identifier by detecting the phone number from which the subscriber is calling and cross-referencing it with an account identifier stored in a database.

The IVR system 240 determines whether it should continue to handle the customer service call (block 906). For example, the IVR system 240 may determine that it should continue handling the call if the calling subscriber presses a number on the number pad of the phone indicating that the subscriber does not wish to speak with a customer service agent or that the subscriber wishes to continue using the IVR system 240.

If the IVR system 240 determines at block 906 that it should continue handling the customer service call, then it determines whether the account is in violation (block 908). For example, the IVR system 240 may check the CRM system 238 and/or the fraud and abuse history data structure 210 to determine whether the account of the calling subscriber is flagged with any violations. If at block 908 the IVR system 240 determines that the calling subscriber's account is flagged with one or more violations, the IVR system 240 retrieves and plays back the pre-recorded audio message (block 910) generated at block 706 of FIG. 7. For example, an abuse response handler of the IVR system 240 may manage the retrieval and playback of the pre-recorded audio message after identifying the subscriber account violation.

After the IVR system 240 plays back the pre-recorded audio message, the IVR system 240 of the illustrated example determines whether to transfer the subscriber call to a customer service agent (block 912). For example, after hearing the pre-recorded audio message, the calling subscriber may select an option on the phone pad to speak with a customer service agent. If at block 912 the IVR system 240 determines that it should not transfer the call to a customer service agent (e.g., the calling subscriber did not elect to speak with a customer service agent) or if the IVR system 240 determines at block 908 that the account of the calling subscriber is not in violation, then the IVR system 240 continues to handle the call using other IVR options (block 914).

If the IVR system 240 determines at block 912 that it should transfer the call to a customer service agent (e.g., the calling subscriber elected to speak with a customer service agent), or, if the IVR system 240 determines at block 906 that it should not continue to handle the customer service call, then the CRM system 238 retrieves and displays to a customer service agent the message indicating the network abuse violation information associated with the account of the calling subscriber (block 916). The message retrieved and displayed by the CRM system 238 is the message that the CRM system 238 generated at block 702 of FIG. 7. The CRM system 238 then transfers the subscriber call from the IVR system 240 to the customer service agent (block 918). The process is then ended.

FIG. 10 is a block diagram of an example processor system that may be used to implement the example apparatus, methods, and articles of manufacture described herein. As shown in FIG. 10, the processor system 1010 includes a processor 1012 that is coupled to an interconnection bus 1014. The processor 1012 includes a register set or register space 1016, which is depicted in FIG. 10 as being entirely on-chip, but which could alternatively be located entirely or partially off-chip and directly coupled to the processor 1012 via dedicated electrical connections and/or via the interconnection bus 1014. The processor 1012 may be any suitable processor, processing unit or microprocessor. Although not shown in FIG. 10, the system 1010 may be a multi-processor system and, thus, may include one or more additional processors that are identical or similar to the processor 1012 and that are communicatively coupled to the interconnection bus 1014.

The processor 1012 of FIG. 10 is coupled to a chipset 1018, which includes a memory controller 1020 and an input/output (I/O) controller 1022. As is well known, a chipset typically provides I/O and memory management functions as well as a plurality of general purpose and/or special purpose registers, timers, etc. that are accessible or used by one or more processors coupled to the chipset 1018. The memory controller 1020 performs functions that enable the processor 1012 (or processors if there are multiple processors) to access a system memory 1024 and a mass storage memory 1025.

The system memory 1024 may include any desired type of volatile and/or non-volatile memory such as, for example, static random access memory (SRAM), dynamic random access memory (DRAM), flash memory, read-only memory (ROM), etc. The mass storage memory 1025 may include any desired type of mass storage device including hard disk drives, optical drives, tape storage devices, etc.

The I/O controller 1022 performs functions that enable the processor 1012 to communicate with peripheral input/output (I/O) devices 1026 and 1028 and a network interface 1030 via an I/O bus 1032. The I/O devices 1026 and 1028 may be any desired type of I/O device such as, for example, a keyboard, a video display or monitor, a mouse, etc. The network interface 1030 may be, for example, an Ethernet device, an asynchronous transfer mode (ATM) device, an 802.11 device, a digital subscriber line (DSL) modem, a cable modem, a cellular modem, etc. that enables the processor system 1010 to communicate with another processor system.

While the memory controller 1020 and the I/O controller 1022 are depicted in FIG. 10 as separate functional blocks within the chipset 1018, the functions performed by these blocks may be integrated within a single semiconductor circuit or may be implemented using two or more separate integrated circuits.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above-described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. Such devices are periodically superseded by faster or more efficient systems having the same general purpose. Accordingly, replacement devices, standards and/or protocols having the same general functions are equivalents which are intended to be included within the scope of the accompanying claims.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A method comprising:
obtaining network service activity information associated with a plurality of network service accounts;
comparing via a fraud detection system the network service activity information with a term of a service agreement of a service provider; and
identifying abusive activity based on the comparison.

2. A method as defined in claim 1, further comprising configuring an interactive voice response system to interact with a subscriber based on the identified abusive activity.

3. A method as defined in claim 1, further comprising storing information in a customer relationship management system to facilitate interaction with a subscriber holder based on the identified abusive activity.

4. A method as defined in claim 3, wherein causing interaction with the subscriber comprises performing an operation to motivate the subscriber to contact a service provider associated with the communication system.

5. A method as defined in claim 4, wherein performing the operation comprises at least one of disabling a user password, changing a user password, or disabling a service.

6. A method as defined in claim 1, wherein the term of the service agreement is at least one of a maximum number of electronic mail addresses during a predetermined time period, a prohibited information condition, or a maximum number of simultaneous user logins.

7. A method as defined in claim 1, wherein the service provider is at least one of an Internet service provider, a telephone service provider, a cable service provider, a satellite service provider, a wireless communication service provider, or a utility service provider.

8. A method as defined in claim 1, wherein identifying the abusive activity comprises determining at least one of whether a number of electronic mail addresses exceeds a threshold value, whether a number of e-mails transmitted within a time period exceeds a threshold value, whether the same subscriber information was used to establish more than a threshold number of accounts, or whether a geographical address associated with one of the network service accounts is valid.

9. A method as defined in claim 1, wherein the abusive activity includes fraudulent activity.

10. A method comprising:
obtaining network service activity information associated with a plurality of network service accounts; and
comparing via a fraud detection system the network service activity information with a term of a service agreement associated with a third-party service provider providing services over a communication channel of a primary service provider.

11. A method as defined in claim 10, further comprising identifying abusive activity based on the comparison.

12. A method as defined in claim 10, further comprising generating a message indicative of the identified abusive activity, and forwarding the message to the third-party service provider.

13. A method as defined in claim 10, wherein the third-party service provider is at least one of an electronic mail service provider, a web page hosting service provider, a message board service provider, a financial services service provider, an Internet protocol television service provider, an Internet radio service provider, an audio media service provider, or a video media service provider.

14. A method as defined in claim 10, further comprising retrieving the term of the service agreement from the third-party service provider when a user is subscribed to a service provided by the third-party service provider.

15. A method as defined in claim 10, further comprising storing the term of the service agreement of the third-party service provider in a server of a primary service provider.

16. A method as defined in claim 10, wherein identifying the abusive activity comprises determining at least one of whether a number of electronic mail addresses exceeds a threshold value or whether a number of e-mails transmitted within a predetermined time period exceeds a threshold value.

17. A method as defined in claim 10, wherein the abusive activity includes fraudulent activity.

18. An apparatus comprising:
a data interface to obtain subscriber accounts data from a plurality of network nodes within a communication system;
a data analyzer communicatively coupled to the data interface to analyze the service accounts data to identify abusive activity; and
an abuse response handler to guide a user communication based on the abusive activity.

19. An apparatus as defined in claim 18, wherein the abuse response handler guides the user communication in response to a user contacting a service provider associated with the communication system.

20. An apparatus as defined in claim 18, wherein the data interface communicates information associated with the fraudulent activity to a customer relationship management system.

21. An apparatus as defined in claim 20, wherein the information associated with the fraudulent activity is associated with performing an operation to motivate a user to contact a service provider associated with the communication system.

22. An apparatus as defined in claim 21, wherein performing the operation comprises at least one of disabling a user password, or changing a user password, or disabling a service.

23. An apparatus as defined in claim 18, wherein the abuse response handler plays back a pre-recorded message or transfers the user to a customer service agent.

24. An apparatus as defined in claim 18, wherein the communication system is an Internet access system.

25. An apparatus as defined in claim 18, wherein the data analyzer determines at least one of whether a number of electronic mail addresses exceeds a threshold value, whether a quantity of e-mails transmitted within a predetermined time period exceeds a threshold value, whether the same subscriber information was used to establish more than a threshold number of accounts, or whether a geographical address associated with a service account is valid.

26. An apparatus as defined in claim 18, wherein the data analyzer compares user activities with a term of a service agreement associated with at least one of a primary service provider or a third-party service provider that provides services via the primary service provider.

27. An apparatus as defined in claim 18, wherein the abusive activity includes fraudulent activity.

28. A machine accessible medium having instructions stored thereon that, when executed, cause a machine to:
obtain subscriber accounts data from a plurality of network nodes within a communication system;
analyze subscriber accounts data to identify patterns indicative of abusive activity; and
store information in a customer relationship management system to facilitate interaction with a subscriber based on the analysis.

29. A machine accessible medium as defined in claim 28, wherein some of the plurality of accounts data is associated with a service type different from another service type associated with others of the plurality of accounts data.

30. A machine accessible medium as defined in claim 29, wherein the service type is at least one of an electronic mail account service or a web page hosting service.

31. A machine accessible medium as defined in claim 28 having the instructions stored thereon that, when executed, cause the machine to facilitate interaction with the subscriber by performing an operation to motivate the subscriber to contact a service provider associated with the communication system.

32. A machine accessible medium as defined in claim 31 having the instructions stored thereon that, when executed, cause the machine to perform the operation by at least one of disabling a user password, or changing a user password, or disabling a service.

33. A machine accessible medium as defined in claim 28 having the instructions stored thereon that, when executed, cause the machine to modify at least one of the plurality of subscriber accounts data based on the analysis.

34. A machine accessible medium as defined in claim 28 having the instructions stored thereon that, when executed, cause the machine to configure an interactive voice response system to interact with an account holder based on the analysis.

35. A machine accessible medium as defined in claim 28, wherein the plurality of the subscriber accounts are associated with computer networking services.

36. A machine accessible medium as defined in claim 28 having the instructions stored thereon that, when executed, cause the machine to analyze the plurality of the subscriber accounts data by determining at least one of whether a quantity of electronic mail addresses exceeds a threshold value, whether more than a threshold quantity of e-mails were transmitted within a predetermined time period, whether the same subscriber information was used to establish more than a threshold quantity of accounts, or whether a geographical address associated with a subscriber account is valid.

37. A machine accessible medium as defined in claim 28, having the instructions stored thereon that, when executed, cause the machine to analyze the plurality of the subscriber accounts data by comparing user activities with a term of a service agreement associated with at least one of a primary service provider and a third-party service provider that provides services via the primary service provider.
